(19) United States
(12) Patent Application Publication
(10) Pub. No.: US 2007/0002835 A1
(43) Pub. Date: Jan. 4, 2007

(54) Edge-based communication

(75) Inventors: Kenneth W. Church, Seattle, WA (US); Kuansan Wang, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/173,281

(22) Filed: Jul. 1, 2005

(51) Int. Cl. H04L 12/66; H04L 12/56

(52) U.S. Cl. 370/352; 370/401

(57) ABSTRACT

An edge-based gateway is employed to provide communication data routing and/or communication data filtering via a plurality of communication mechanisms without utilization of a centralized authority. This allows communication data routing between older, current, and/or future communication mechanisms such as POTS, cellular networks, and/or the Internet and the like. These communication mechanisms blend together via the edge-based gateway, allowing communication data to pass seamlessly through the communication mechanisms to an end-user, despite where and/or how the communication was placed. Since the gateway is edge-based, each user can individually constrain its functionality if desired. The edge-based gateway also facilitates in substantially reducing communication costs by allowing users to utilize cost-effective communication mechanisms to communicate with local edge-based gateways that can then access global networks and communicate with other edge-based gateways in a local region to the desired end-user.

### BACKGROUND

The ability to communicate is fundamental to the welfare of society. The ease at which this ability can be achieved generally controls the level of information disseminated within the society. Thus, individuals become more knowledgeable and able to contribute more to society when communication is easily obtained. However, despite modern society's embrace of technology, there are still substantial gaps in the coverage of present day communication techniques. This, along with the rising costs of communicating, leaves large portions of the world void of convenient communications. For example, satellite-based communication devices theoretically can allow communications anywhere on earth that can be reached by a satellite. Nevertheless, the extreme cost of using this technology, including both the high cost of the communication device and the high cost of the service, prohibits most people from adopting this technology as an everyday communication means.

More traditional means of communication, like “plain old telephone service/system” or POTS for example, continue to dominate communications because of their early adoption as a communication standard. This initial “leg up” on other communication means provides a substantial barrier to the acceptance of newer technologies. Established communications are generally slow to change and, thus, transitions to newer technologies take a substantial period of time. Because of the initial head start, established communications have generally already paid for their communication network infrastructures and also developed inexpensive communication devices for use with their systems. This type of service generally utilizes a mix of analog and digital signals transmitted over wires (or in some cases, fiber optics, etc.). It is likely, given enough time, that traditional landline telephones will be displaced by emerging technologies such as cell phone and VOIP (voice over Internet protocol) and the like.

Wireless communication networks can more easily be erected in new areas than traditional telephone landlines, but, due to the substantial cost of a single transmitter, the amount of potential customers required to make the transmitter cost-effective limits coverage of wireless service in rural areas. Whereas, a traditional telephone landline network can expand to a single customer in a new area with only the cost of the wire needed to complete the connection. Because of these ‘economic factors,’ the two types of communication networks often do not have overlapping coverage areas. Generally, rural areas will have traditional telephone service, while city areas will have both wireless and telephone network services. In areas without a permanent telephone communication device installed, such as in a city park, it is possible that a wireless transmitter may provide coverage, while a traditional telephone service cannot, by its nature of requiring wired communication devices, provide any services.

Additional influences, such as, for example, weather conditions and service demands (especially during emergencies) can greatly impact the availability of either type of service. For instance, while high winds may bring down a telephone pole disabling the telephone lines, the wireless transmitter 50 miles away may be unaffected and able to provide communications. Thus, both types of systems may enhance communications by providing both redundant (e.g., increased communication reliability) and non-redundant services (e.g., increased communication coverage). It is also possible that one service is priced more cost effectively than the other service in different areas, reducing the costs of communications.

The Internet has impacted communications as well. It is a growing technology in the sense that not all areas of the world have access to it, but it has far surpassed many other communication means in its phenomenal growth rate. Originally intended as a scientific communication endeavor, the Internet has been embraced by society as a means to communicate on a global scale, reaching millions, if not billions, of people worldwide. It allows information to be disseminated at a rate never before achievable, even by television cable systems which dominated communications for many decades. The Internet utilizes a network of computers to allow fast communications between great distances, with little or no associated costs (aside from local internet access fees which are generally for unlimited usage). Part of its growth is due to the fact that computers, and specifically personal computers, had already been adopted and were in use in many homes and businesses before the Internet came into fruition. Thus, the ‘communication device’ cost was already borne by the end-user, making communication costs almost non-existent. The allure of such an inexpensive communication means fueled technological developments to utilize the Internet for all different types of communications—from text to voice to visual communications, not to mention data communications for which it was originally designed. Technologies, such as voice over internet protocol or “VOIP,” have been developed that allow end-users to talk to one another via VOIP phones that convert analog voice into digital data that can be transmitted all over the world, drastically reducing long distance communication costs. Despite its very strong cost effectiveness, the Internet has a severe drawback in that an end-user must be at or near a computer in order to utilize this technology.

Recent technology developments have attempted to rectify the shortcomings of different types of communication means by utilizing hybrid communication systems that employ two different types of communications. However, in a system that is inherently designed to support a business model, there must be a central means of controlling the communication network. This allows the system owner to charge for their services, often on an individual call basis. To accomplish this, central routing services at a network location handle all incoming and outgoing calls for that particular communication network. This allows all traffic on the communication system to be monitored and subsequently billed to customers. In current hybrid communication systems, for example, a computer can be utilized to place a VOIP call to a wireless device, but the VOIP call must be routed to a central control center of the network which controls VOIP to wireless number lookup and the actual dialing out on the wireless network. Users are then charged based on the VOIP call and the wireless call placed by at the central communication network center. This type of “billable” communication system is built upon the traditional telephone communication networks that utilized a central switchboard which was manned by an operator. Eventually, the operator was replaced by mechanical and then electrical switches to complete the connections. It is this “centralized” control that is thematic of communication systems found today.

Despite the progression of technology in various different areas of communications, there is not always one technology that is far superior to another. A set of circumstances can easily change, allowing one technology to outshine another. A user might be indoors at a computer and placing a VOIP call might be accomplished easily and with minimal cost. Another user might be at a soccer game and a wireless service might be the only means of communication even though at a higher cost than a VOIP call. Yet another user might not be able to afford a computer and utilizes only a traditional telephone system. Thus, it is highly desirable to be able to easily transverse these diverse communication means to be able to reach these users in a cost effective manner and without requiring the intervention of a centralized authority that can invade the privacy of a user and limit communication flexibility.

### SUMMARY

The following presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

The subject matter relates generally to communication, and more particularly to systems and methods for relaying communication data at the edge of a network. An edge-based gateway is employed to provide communication data routing and/or communication data filtering via a plurality of communication mechanisms, notwithstanding their compatibility, and without utilization of a centralized authority. This allows communication data routing between older, current, and/or future communication mechanisms such as POTS, cellular networks, and/or the Internet and the like. These communication mechanisms blend together via the edge-based gateway, allowing communication data to pass seamlessly through the communication mechanisms to an end-user, despite where and/or how the communication was placed. When the edge-based gateway is utilized with a computing device, it allows easy integration of communications with computing tasks. This enhances the utility of the computing devices by providing increased flexibility of resources available to it.

Because the gateway is edge-based, each end-user can individually constrain its functionality if desired, permitting unparalleled communication control. The edge-based gateway also reduces barriers to communication that arise when a user's location changes causing a change in available communication mechanisms. Thus, for example, an end-user can be reached via a laptop computer even though the initial communication mechanism occurred via a cell phone. The edge-based gateway also facilitates in substantially reducing communication costs by allowing end-users to utilize cost-effective communication mechanisms such as, for example, cell phones to communicate with local edge-based gateways that can then access global networks and communicate with other edge-based gateways in a local region to the desired end-user, even if the desired end-user is not in the immediate vicinity of the edge-based gateway.

To the accomplishment of the foregoing and related ends, certain illustrative aspects of embodiments are described herein in connection with the following description and the annexed drawings. These aspects are indicative, however, of but a few of the various ways in which the principles of the subject matter may be employed, and the subject matter is intended to include all such aspects and their equivalents. Other advantages and novel features of the subject matter may become apparent from the following detailed description when considered in conjunction with the drawings.

### BRIEF DESCRIPTION OF THE DRAWINGS

FIG. 1 is a block diagram of an edge-based communication system in accordance with an aspect of an embodiment.

FIG. 2 is another block diagram of an edge-based communication system in accordance with an aspect of an embodiment.

FIG. 3 is yet another block diagram of an edge-based communication system in accordance with an aspect of an embodiment.

FIG. 4 is a flow diagram of a method of facilitating communication in accordance with an aspect of an embodiment.

FIG. 5 is a flow diagram of a method of facilitating communication filtering in accordance with an aspect of an embodiment.

FIG. 6 is a flow diagram of a method of facilitating communication based on an end-user's availability in accordance with an aspect of an embodiment.

FIG. 7 illustrates an example operating environment in which an embodiment can function.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It may be evident, however, that subject matter embodiments may be practiced without these specific details. In other instances, well-known structures and devices are shown in block diagram form in order to facilitate describing the embodiments.

As used in this application, the term “component” is intended to refer to non-computer related entity (e.g., a telephonic hardware and/or software facilitating device) and/or a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a computer component. One or more components may reside within a process and/or thread of execution and a component may be localized on one computer and/or distributed between two or more computers. A “thread” is the entity within a process that the operating system kernel schedules for execution. As is well known in the art, each thread has an associated “context” which is the volatile data associated with the execution of the thread. A thread's context includes the contents of system registers and the virtual address belonging to the thread's process. Thus, the actual data comprising a thread's context varies as it executes.

Systems and methods are provided that allow different communication modalities to interconnect utilizing a communications gateway that resides at the edge of a network. The edge-based gateway eliminates the need for a centralized system of communication control and permits an end-user to personalize their means of communication contact. Thus, instead of a centralized entity determining how communication data is routed, and at what cost, the edge-based gateway can be utilized to route communications as an end-user sees fit. Because the gateway is edge-based, it can be more easily “tuned” to increase performance (and filtering) of communication routing on an individual basis—something a centralized entity cannot accomplish. The edge-based gateway can interface with a plurality of communication as well as computing mechanisms with little or no additional costs while preserving such aspects as user privacy and/or system flexibility and the like. For example, when utilized with a personal computer, an edge-based gateway can easily integrate the Internet, traditional wired telephone systems, and/or wireless systems with the computing resources such as personal information management (PIM), presence, digital contents, and/or desktop search, etc. Communication data is routed via the gateway through an appropriate communication mechanism. The appropriate communication mechanism can be predetermined, based on an end-user's location, and/or be dynamically determined based on the best cost efficiency and the like.

Edge-based gateways permit peer-to-peer communications without the necessity of a centralized repository database of mappings of data (e.g., telephone numbers to IPs, etc.) and/or centralized control. Communications are established between end-users, typically utilizing a personal computer to host edge-based gateway functionality. This avoids the traditional communication model with a centralized authority that maintains directories for assisting communications. As a result, features that are expensive to provide in a centralized architecture can be very cost effective by leveraging the computation resources on the edges. For example, personalized services would require the centralized servers to store customized data. This arrangement poses significant challenges in terms of service operation, scalability, privacy, and flexibility if the number of clientele is large. In contrast, if the services are provided at the edge using a personal computer, customized data can be stored locally and updated frequently as the user sees fit. However, it also manifests itself as a different model in accounting for individual calls and/or tracking of the duration of calls in that the power or control of what and/or when and/or how communications are communicated is given to the individual end-users rather than the central monopolistic authority.

Some VOIP-based technologies allow peer-to-peer communications utilizing a single communication mechanism such as the Internet. Some other VOIP-based technologies have multiple communication mechanisms that must include centralized servers. In sharp contrast, the systems and methods provided herein interface with a plurality of communication mechanisms without the need of a centralized authority. This permits different communication mechanisms to interact autonomously without necessitating involvement by an end-user. Nevertheless, the end-user can still adjust an edge-based gateway to tailor it to their personal tastes if desired, without having to subject their configurations to any other authority. Thus, the edge-based gateway substantially increases the flexibility, privacy, and control that an end-user has over their communication system, vastly increasing its utility and value without requiring additional investments in expensive communication equipment or paying centralized authority monthly communication charges.

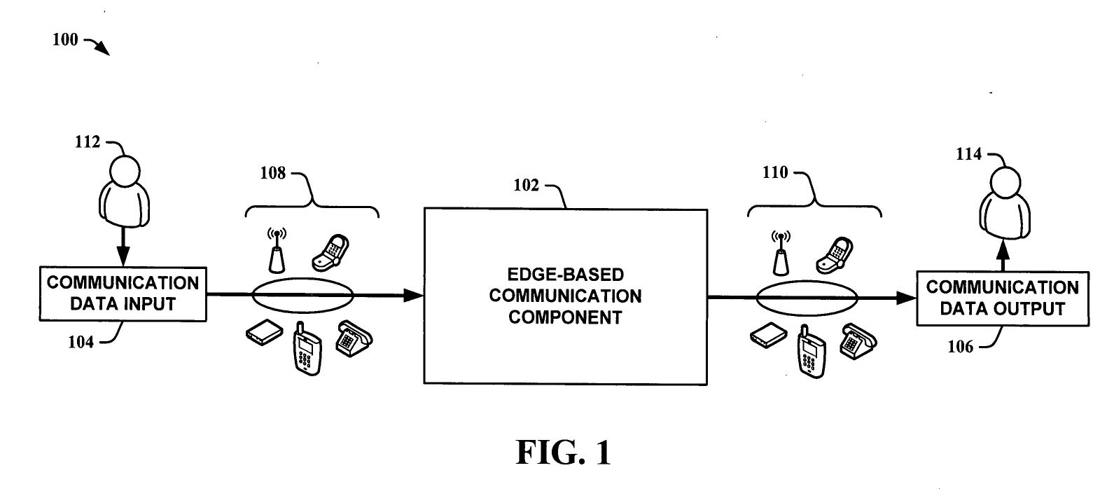

In FIG. 1, a block diagram of an edge-based communication system 100 in accordance with an aspect of an embodiment is shown. The edge-based communication system 100 is comprised of an edge-based communication component 102 that obtains a communication data input 104 via an input communication mechanism 108 and relays a communication data output 106 via an output communication mechanism 110. The input 108 and output 110 communication mechanisms can be of a single type and/or different types of mechanisms. They 108, 110 can also be comprised of more than one type of mechanism each. The communication mechanisms can include, but are not limited to, cellular communications, long-established traditional communications (e.g., traditional landline telephone systems and the like), satellite communications (e.g., satellite telephones and the like), non-traditional communications (e.g., bluetooth, infrared, and the like), and/or network communications (e.g., global communication networks (e.g., the Internet), intranets, WANs, LANs, and the like) and the like.

The communication data can also include, but is not limited to, combined data that can be obtained via a plurality of communication mechanisms. For example, User A 112 can send voice communication data via VOIP while spreadsheet data is sent via a cellular telephone system. The edge-based communication component 102 can determine a common recipient, User B 114, and relay both types of communication data via a single type (or multiple types) of communication mechanism(s) to User B 114. The communication data itself can include, but is not limited to, voice data, email data, instant messaging data, and/or text data and the like.

The functionality of the edge-based communication component 102 can reside, for example, in a personal computer, a personal digital assistant (PDA), a smart phone, a telephone modem, a telephone answering device, and/or a stand-alone device and the like. Thus, initial investment costs can be substantially reduced by utilizing existing devices and/or existing communication mechanisms. Because the edge-based communication component 102 resides “at the edge,” an end-user remains in control of the communication data routing and the costs of relaying the communication data. Thus, no central authority tracks and/or bills for the routing of the communication data, preserving the end-user's privacy and/or saving the end-user money.

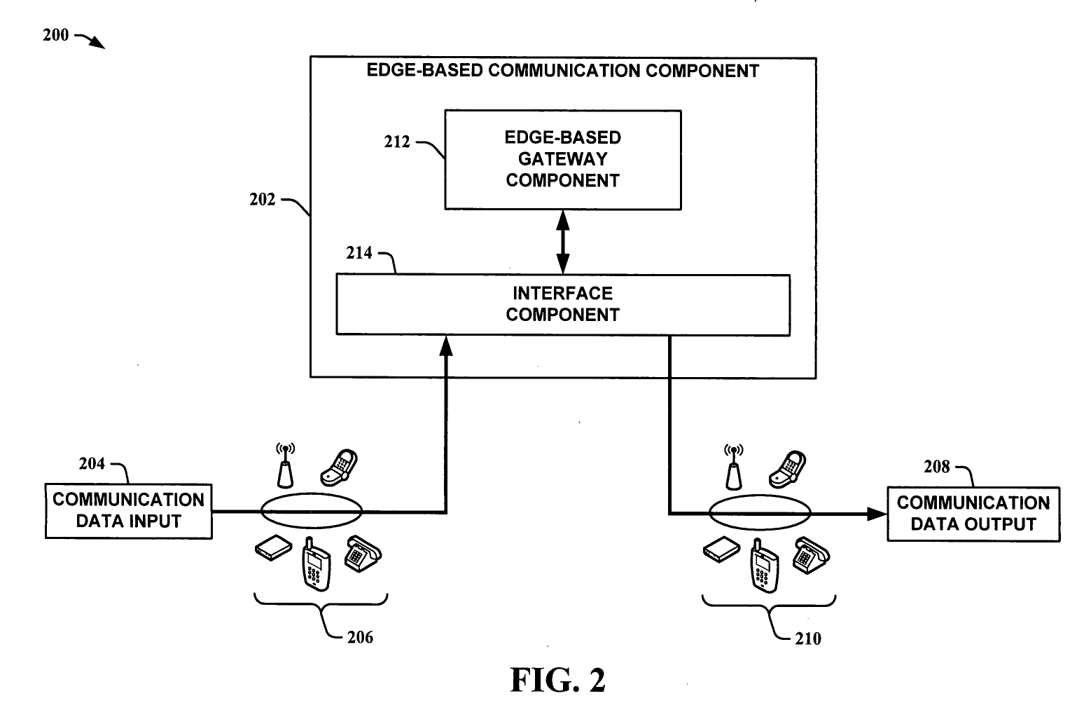

Turning to FIG. 2, another block diagram of an edge-based communication system 200 in accordance with an aspect of an embodiment is depicted. The edge-based communication system 200 is comprised of an edge-based communication component 202 that obtains a communication data input 204 via an input communication mechanism 206 and relays a communication data output 208 via an output communication mechanism 210. The input 204 and output 208 communication mechanisms can be of a single type and/or different types of mechanisms. They 204, 208 can also be comprised of more than one type of mechanism each. The communication mechanisms can include, but are not limited to, cellular communications, long-established traditional communications (e.g., traditional telephone landline systems and the like), satellite communications (e.g., satellite telephones and the like), non-traditional communications (e.g., bluetooth, infrared, and the like), and/or network communications (e.g., global communication networks (e.g., the Internet), intranets, WANs, LANs, and the like) and the like. The communication data can also include, but is not limited to, combined data that can be obtained via a plurality of communication mechanisms. The communication data itself can include, but is not limited to, voice data, email data, instant messaging data, and/or text data and the like.

The edge-based communication component 202 is comprised of an edge-based gateway component 212 and an interface component 214. The interface component 214 interfaces with a plurality of communication mechanisms to obtain and/or relay communication data. The edge-based gateway component 212 receives communication data from the interface component 214 and determines at least one appropriate communication mechanism to facilitate routing of the communication data input 204. It 212 then relays the communication data input 204 to an end-user via the interface component 214 and the appropriate communication mechanism(s) (which in this illustration is shown as output communication mechanism 210). The edge-based gateway component 212 can determine an appropriate communication mechanism based on, for example, a location of an end-user, availability of an end-user, a universal resource locator (URL), communication data routing cost-effectiveness, and/or predetermined communication data routing and the like.

The interface component 214 can also reside within/on a hardware component separate from the host of the edge-based gateway component 212. The interface component 214 can also be comprised of a plurality of hardware components. For example, the interface component 214 can include, but is not limited to, a POTS interface, a wireless interface, an Internet interface, and/or other communication mechanism type interfaces and the like. These different types of interfaces can require unique interface hardware that is not cost effectively found in a single specialty device. Thus, cost effectiveness and/or ease of implementation can drive the utilization of a compound interface component. On the other hand, for example, a properly equipped personal computer can provide the communication interfaces within a single component. Thus, the systems and methods disclosed herein provide great flexibility in the types and/or complexity of the supporting equipment. A typical end-user will generally already possess a substantial portion of the interfacing equipment, negating a substantial initial investment to utilize edge-based gateway technology.

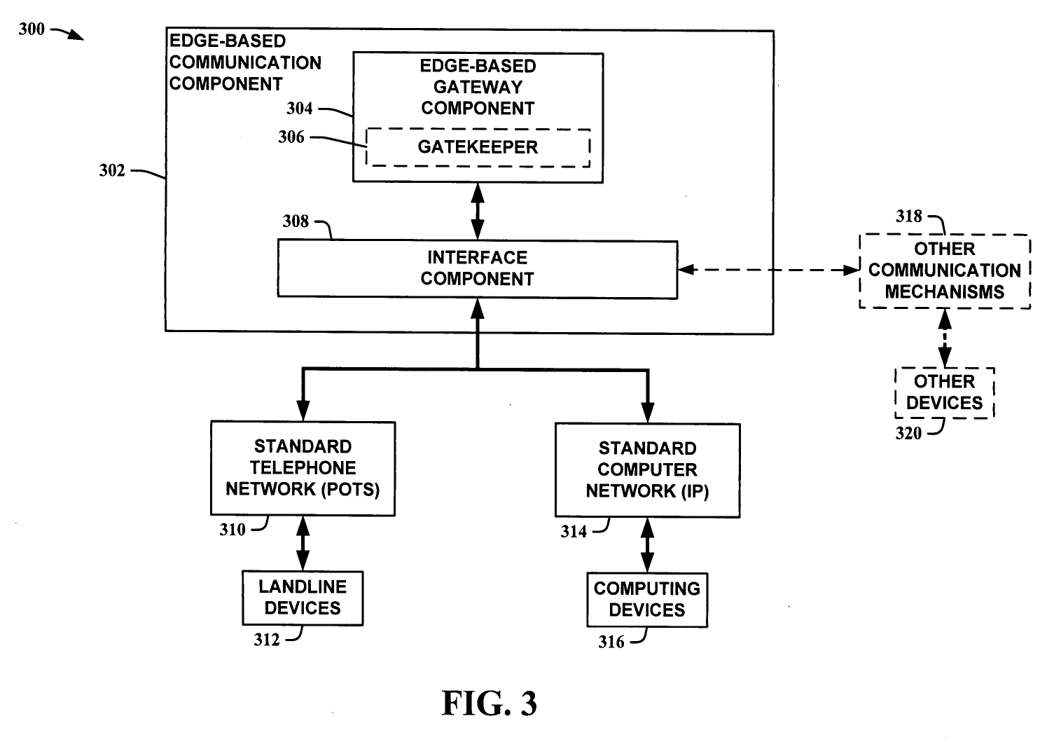

Looking at FIG. 3, yet another block diagram of an edge-based communication system 300 in accordance with an aspect of an embodiment is illustrated. The edge-based communication system 300 is comprised of an edge-based communication component 302 that interfaces with a standard telephone network (POTS) 310 utilizing landline devices 312 and with a standard computer network (IP) 314 utilizing computing devices 316. The edge-based communication component 302 is comprised of an edge-based gateway component 304 with an optional gatekeeper component 306 and an interface component 308. The optional gatekeeper component 306 filters undesirable communication data from being routed by the edge-based gateway component 304. The filtering can be based on end-user preferences, cost-effectiveness, importance, timeliness, user, end-user availability, end-user location, and/or data amount and the like. The optional gatekeeper component 306 provides a substantial amount of communication control to an end-user. The communication data can be blocked (e.g., discarded, returned, etc.), re-routed (e.g., sent to voice mail, answer machine, etc.), and/or delayed (e.g., forwarded when end-user is available, etc.) and the like. In traditional centralized communication systems, a portion of these types of services might be available, but typically at some cost to the end-user and without the availability of substantial end-user tailoring and privacy.

The interface component 308 interfaces with a plurality of communication mechanisms such as, for example, the standard telephone network 310 and the standard computer network 314 and the like. This permits a seamless communication integration of the standard telephone network 310 and the standard computer network 314 via utilization of the edge-based communication component 302. For example, an end-user can be reached by a landline telephone via their laptop computer without the originating caller knowing that the end-user is at a remote location and using a laptop for communications. The originating caller places the call employing traditional telephone numbers and a landline telephone. However, the edge-based communication component 302 relays the incoming landline call over the standard computer network 314 to the end-user. Similarly, the originating caller can utilize their computer to place a call to the end-user who has configured the edge-based communication component 302 to relay their incoming calls to their computer to a landline telephone via the standard telephone network 310. As before, the originating caller is not necessarily aware that the end-user was called via a landline. The end-user can also utilize the edge-based communication component 302 to filter unwanted incoming calls and/or provide notice to the originating caller concerning availability of the end-user and the like. This permits substantial flexibility, privacy, and/or cost efficiencies to be realized over traditional communication means.

The edge-based gateway component 302 can also facilitate in integrating computing devices with available communication mechanisms. This increases the functionality and enhances the value of both hardware and software aspects of computing. For example, if a laptop is able to seamlessly provide communications via a plurality of mechanisms, it follows that the laptop user will also gain increased communication coverage, and, in turn, increased availability of that particular end-user to those they desire to communicate with. In a similar fashion, software applications can be enhanced utilizing the edge-based gateway component 302 as well. For example, a search engine can employ the edge-based gateway component 302 to provide access, not only to Internet-based information sources, but also to telephonic-based information sources as well. Thus, when an end-user searches for information about a person, the search engine can search the Internet as well as call database depositories via a landline and/or cellular telephone. Another example might include a news media based software application that requires ‘instant’ notification of late breaking news. Individuals rather than “centralized news services” can create their own desktop news services that employ all available communication mechanisms to reach their “subscribers” (e.g., friends, family, etc.) for “hot” news about the birth of a new member of the family. The first photo of the baby can be instantly delivered via the Internet, cellular telephone, landline telephone, and/or fax machine and the like. One skilled in the art can appreciate that the few examples described above do not limit the scope of the systems and methods provided herein. Edge-based gateways integrated with computing devices create powerful applications that were not previously available to an individual end-user.

The interface component 308 can also interface to other communication mechanisms 318 utilizing other devices 320. These other communication mechanisms 318 can include, but are not limited to, cellular networks, public switched telephone networks (PSTN), private communication networks, global communication networks (e.g., the Internet), and/or combinations/hybrids of communication mechanisms and the like. One skilled in the art can appreciate that the subject matter presented herein is not limited to a specific communication mechanism type and that other additional communication mechanisms are still within the scope of the subject matter. These include, but are not limited to, communication mechanisms not explicitly described such as, for example, traditional, non-traditional, current, and/or future communication mechanisms compatible with the systems and methods described herein. Other devices 320 can include, but are not limited to, wireless devices such as, for example, cell phones, smart phones, wireless PDAs, and the like; landline devices 320 such as, for example, telephones, modems, and/or fax machines and the like; computing devices 322 such as, for example, personal computers, smart phones, PDAs, network only terminals, and/or VOIP phones and the like; and/or devices such as, for example, bluetooth, infrared, RF, light wave, magnetic, and/or other traditional, current, and/or future communication devices and the like.

The communications sector is largely based on POTS technology. In the near future, Internet-based communication technologies (e.g., VOIP) will likely play an ever important role in communications. Edge-based gateways can provide a means for facilitating the migration and integration of telephony from POTS to VOIP by enabling these two telephony modalities to coexist and interact. The utilization of gateways allows communications despite the different communication modalities that are utilized by millions of users on different sides of these technologies (e.g., Internet telephony users versus traditional telephony users). Deployment of gateways and gatekeepers during a transitional telephony phase can facilitate in easing the difficulties that arise if dramatic, and sometimes traumatic, interruption of traditional services occurs. Edge-based gateways/gatekeepers can be utilized by millions of end-users with minimal hardware investments beyond what they already possess (no expensive servers, PBX's, switchers, routers, etc. are required). Edge-based gateways/gatekeepers also move control of the communications from a centralized location (e.g., telephone companies and/or Internet VOIP companies) to individual end-users, increasing communication robustness. Network-based technologies require expensive equipment, and those costs are traditionally passed to the end consumer, increasing the end-user's communication costs. By utilizing edge-based gateways/gatekeepers, the consumer does not have to bear these costs because additional expensive equipment is not necessary. Edge-based gateways also preserve the privacy of the end-user such as the end-user's location, who is communicating with them, and/or personal contact information and the like.

Telephone company strategists often utilize answering machines as the canonical example. An end-user can go to a store and buy an inexpensive answering machine (i.e., edge-based solution), or they can call a centralized communication provider and subscribe to voice mail (i.e., network-based solution). There is demand for both. Large enterprises will gravitate toward expensive (reliable) network-based solutions since they already have investments in PBX's and IT organizations, whereas small businesses and consumers are more price sensitive. On the supply side, telephone companies prefer network-based solutions where they have an advantage (control of the network as well as a core competence in running call centers and comp centers at scale). Other parties can benefit by looking for edge-based solutions that allow their customers to have a choice as to whether or not they want to pay for expensive operations. Gateways are similar in strategy to answering machines. There will be demand for both network-based as well as edge-based gateways; large businesses with large IT shops might gravitate toward network-based (PBX) solutions whereas small businesses and consumers might prefer more affordable edge-based gateways. On the supply side, telephone companies will generally continue to promote network-based gateways, whereas other parties might move toward providing more affordable edge-based gateway alternatives as discussed infra.

A simplified edge-based system, for example, can be constructed from readily available equipment/services such as, for example, a broadband connection to the Internet, a POTS landline, a personal computer (PC) with connections for the Internet and the POTS landline, and a cellular telephone. With this simple system and appropriate edge-based technology, the following communication scenarios can be accomplished:

Scenario A:

VOIP→cellular telephone: VOIP (voice over IP) call comes into the PC via the Internet connection. The PC can decide to forward the call to the cellular telephone. The call is then relayed from the PC to the landline connection to the cellular telephone. If the PC has cellular capabilities, the call can be relayed directly from the PC to the cellular telephone.
   Scenario B:
Cellular telephone→VOIP: An end-user utilizes their cellular telephone to call their PC because they want to check their messages, and they are not near a computer. The call comes into the PC on the landline connection. Someone left a message asking the end-user to call them back. The PC then decides to forward the call to that someone via the Internet wire utilizing VOIP.

With an edge-based gateway architecture, the above system can be accomplished by connecting both the Internet and the landline connections to the PC and configuring the PC accordingly to pass calls back and forth between the two networks or communication mechanisms. Compatibility between POTS and VOIP type communication mechanisms can be facilitated by viewing VOIP as merely the next version of POTS. For example, suppose the gateway translated POTS into VOIP and vice versa, with forward and backward compatibility. Thus, old POTS software could work on VOIP and new VOIP software could work on POTS type communication mechanisms via compatibility translations at the edge-based gateway. There are also many alternative devices that can facilitate the edge-based gateway functionality: cable/DSL modems, telephones, answering machines, and/or a special purpose built box (e.g., running a lightweight version of a computer operating system) and the like.

Edge-based gateways can facilitate communications independent the number of end-users. If only a single end-user employed an edge-based gateway, they can gain the benefits of being able to utilize both the telephone network (POTS, etc.) and the Internet (VOIP, etc.) interchangeably as if they were one network. Anyone who wants to reach the end-user would have to go through the end-user's gatekeeper, so they can get fewer calls from people they do not want to talk to by utilizing the edge-based gatekeeper to filter their calls. Additional benefits can be achieved, however, if millions of users around the world employed edge-based gateways (and they allow others to employ their POTS lines to make local calls from time-to-time), there would no longer be a need to pay toll charges to a centralized communication company.

Integrating the gateway and gatekeeping functions into a personal computer (PC) has advantages and disadvantages. Initial deployment is easier in the general purpose PC environment where upgrading the software is easier. Integrating gateway/gatekeeping functionality with additional products such as email, text messaging, and/or instant messaging products and the like is easier if these reside on the same platform. On the other hand, special purpose devices like modems and answering machines and the like often have better availability/reliability for communication purposes than general purpose PCs which are frequently turned off by end-users.

Edge-based gateways/gatekeepers also allow the eventual elimination of telephone numbers, or at least, the demotion of them to the status of IP (internet protocol) addresses. No one other than an end-user's PC would know the end-user's phone numbers. Instead of giving someone a telephone number, or a cell phone number, an end-user would give them their URL (universal resource locator). If someone desired to call the end-user, they can have their PC call the end-user's PC, and the end-user's PC can decide whether to contact the end-user, or take a message, etc. This places a substantial amount of communication control in the end-user's hands that was traditionally held by a centralized communication company. Routing details like telephone numbers and IP addresses can be kept private to an end-user's routers. Others do not need to know if the end-user is working at their PC or if the end-user is using a cell phone or an 802.11 PDA, etc.

Widespread deployment of inexpensive edge-based gateways can facilitate to make telephone numbers interchangeable with IP addresses, eliminating the need to charge for telephone numbers. This scenario also implies that URLs and/or some equivalent addressing means can replace a country's telephone numbering plan. Telephone numbers can then be downgraded to the status of IP addresses. And, if an end-user happened to connect their PC to a web enabled mobile device (such as a personal digital assistant (PDA), etc.), there may not be any phone numbers involved (at least at the end-user's end) when utilizing edge-based gateway technologies. Additionally, edge-based gateways allow integration of existing gateways, bridges, and/or routers and the like (i.e., communication mechanisms) rather than requiring acquisition of additional equipment (and at additional costs). The integration can now occur at the edge by end-users rather than via centralized communication entities, including those entities providing services on the Internet and via traditional communication mechanisms.

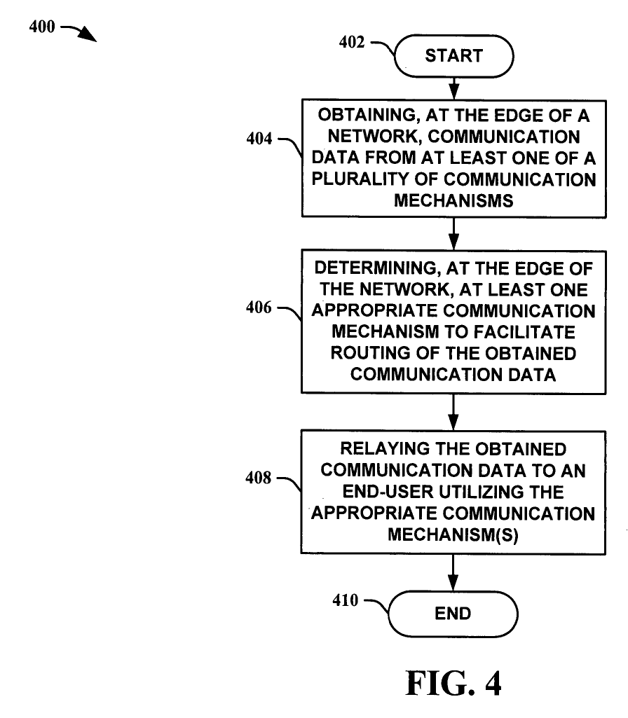

In view of the exemplary systems shown and described above, methodologies that may be implemented in accordance with the embodiments will be better appreciated with reference to the flow charts of FIGS. 4-6. While, for purposes of simplicity of explanation, the methodologies are shown and described as a series of blocks, it is to be understood and appreciated that the embodiments are not limited by the order of the blocks, as some blocks may, in accordance with an embodiment, occur in different orders and/or concurrently with other blocks from that shown and described herein. Moreover, not all illustrated blocks may be required to implement the methodologies in accordance with the embodiments.

The embodiments may be described in the general context of computer-executable instructions, such as program modules, executed by one or more components. Generally, program modules include routines, programs, objects, data structures, etc., that perform particular tasks or implement particular abstract data types. Typically, the functionality of the program modules may be combined or distributed as desired in various instances of the embodiments.

In FIG. 4, a flow diagram of a method 400 of facilitating communication in accordance with an aspect of an embodiment is shown. The method 400 starts 402 by obtaining communication data from at least one of a plurality of communication mechanisms at the edge of a network 404. The communication mechanisms can include, but are not limited to, cellular communications, long-established traditional communications (e.g., traditional telephone landline systems and the like), satellite communications (e.g., satellite telephones and the like), non-traditional communications (e.g., bluetooth, infrared, and the like), and/or network communications (e.g., global communication networks (e.g., the Internet), intranets, WANs, LANs, and the like) and the like. The communication data can also include, but is not limited to, combined data that can be obtained via a plurality of communication mechanisms. The communication data itself can include, but is not limited to, voice data, email data, instant messaging data, and/or text data and the like. At least one appropriate communication mechanism is then determined to facilitate routing of the obtained communication data 406. Determination of an appropriate communication mechanism can be based on, for example, a location of an end-user, availability of an end-user, a universal resource locator (URL), communication data routing cost-effectiveness, and/or predetermined communication data routing and the like. The obtained communication data is then relayed to an end-user utilizing the appropriate communication mechanism(s) 408, ending the flow 410.

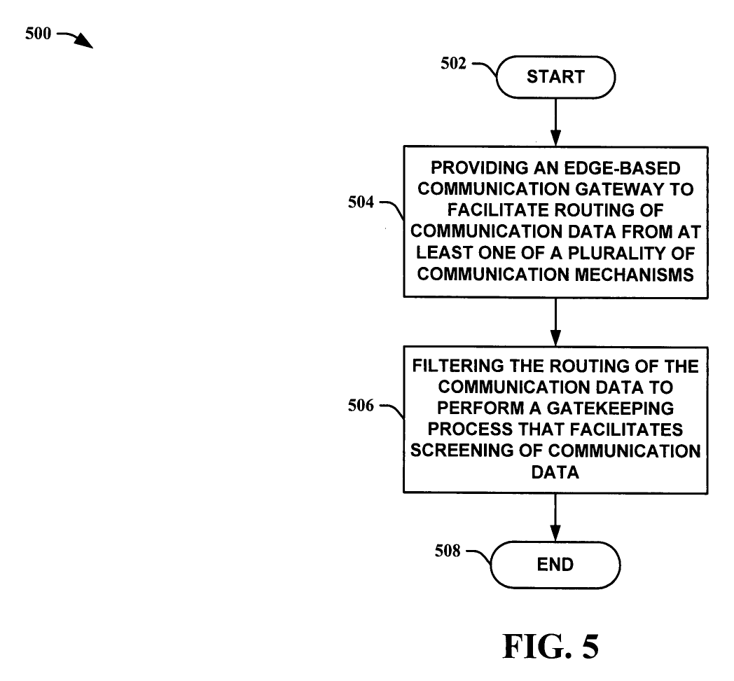

Turning to FIG. 5, a flow diagram of a method 500 of facilitating communication filtering in accordance with an aspect of an embodiment is depicted. The method 500 starts 502 by providing an edge-based communication gateway to facilitate routing of communication data from at least one of a plurality of communication mechanisms 504. The routing of the communication data is then filtered by a gatekeeping process that facilitates screening of communication data 506, ending the flow 508. The filtering can be based on end-user preferences, cost-effectiveness, importance, timeliness, user, end-user availability, end-user location, and/or data amount and the like. This provides a substantial amount of communication control and privacy to an end-user. The communication data can be blocked (e.g., discarded, returned, etc.), re-routed (e.g., sent to voice mail, answer machine, etc.), and/or delayed (e.g., forwarded when end-user is available, etc.) and the like. In traditional centralized communication systems, a portion of these types of services might be available, but typically at some cost to the end-user and without the availability of substantial end-user tailoring and/or privacy.

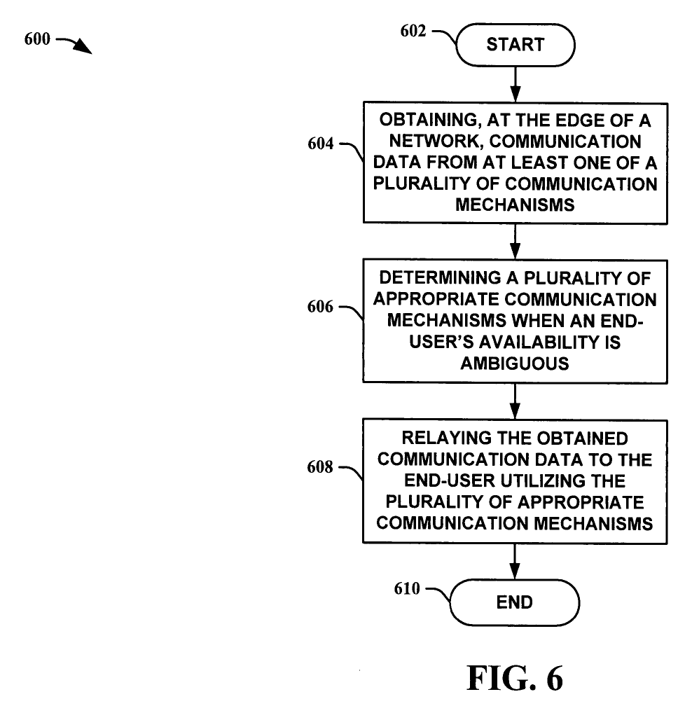

Looking at FIG. 6, a flow diagram of a method 600 of facilitating communication based on an end-user's availability in accordance with an aspect of an embodiment is illustrated. The method 600 starts 602 by obtaining communication data from at least one of a plurality of communication mechanisms at the edge of a network 604. The communication mechanisms can include, but are not limited to, cellular communications, long-established traditional communications (e.g., traditional telephone landline systems and the like), satellite communications (e.g., satellite telephones and the like), non-traditional communications (e.g., bluetooth, infrared, and the like), and/or network communications (e.g., global communication networks (e.g., the Internet), intranets, WANs, LANs, and the like) and the like. The communication data can also include, but is not limited to, combined data that can be obtained via a plurality of communication mechanisms. The communication data itself can include, but is not limited to, voice data, email data, instant messaging data, and/or text data and the like.

A plurality of appropriate communication mechanisms is then determined when an end-user's availability is ambiguous 606. The obtained communication data is then relayed to the end-user utilizing the plurality of appropriate communication mechanisms 608, ending the flow 610. This allows edge-based decision making to increase the likelihood that the end-user is reached with the communication data. For example, if a husband desires, at all cost, to be reached if his pregnant wife is ready to deliver their baby, he can establish an urgent priority for any communication data from his wife. If he is on business travel, it is possible that he could be reached via landline (e.g., at hotel or business location), cell phone, and/or laptop computer connected to the Internet. Thus, the relaying of his wife's communication can occur over all three different types of communication mechanisms, substantially increasing the likelihood that he will be notified of the birth of his child. The selectable choices can also be reduced for cost reasons and/or availability of the communication mechanism and the like.

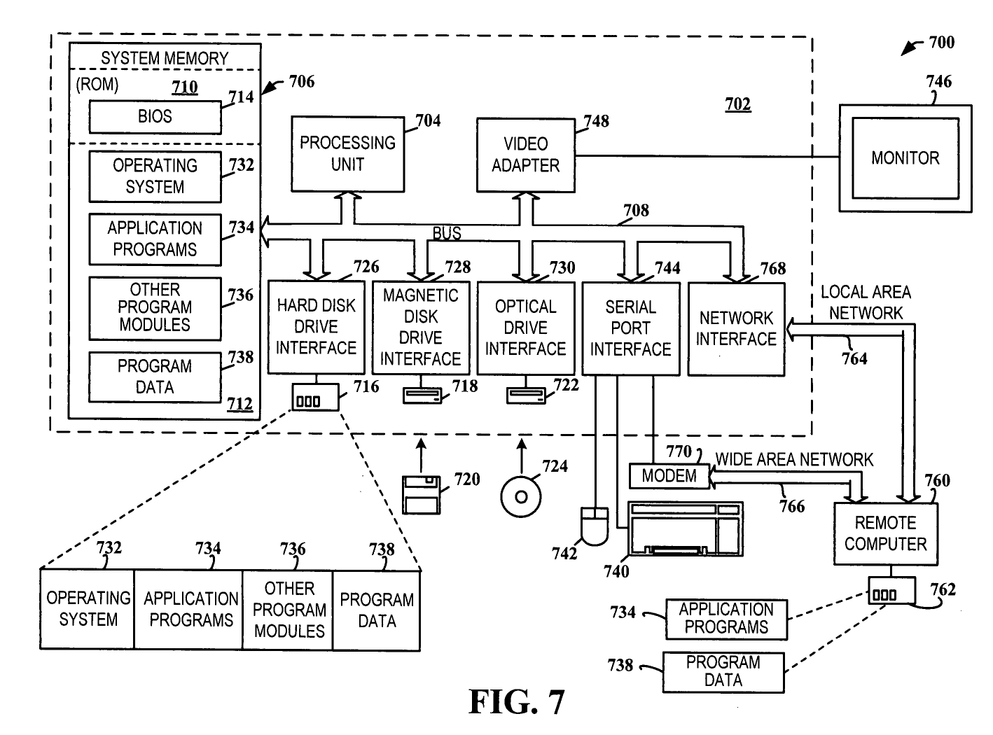

In order to provide additional context for implementing various aspects of the embodiments, FIG. 7 and the following discussion is intended to provide a brief, general description of a suitable computing environment 700 in which the various aspects of the embodiments may be implemented. While the embodiments have been described above in the general context of computer-executable instructions of a computer program that runs on a local computer and/or remote computer, those skilled in the art will recognize that the embodiments may also be implemented in combination with other program modules. Generally, program modules include routines, programs, components, data structures, etc., that perform particular tasks and/or implement particular abstract data types. Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the embodiments may also be practiced in distributed computing environments where certain tasks are performed by remote processing devices that are linked through a communications network. However, some, if not all, aspects of the embodiments may be practiced on stand-alone computers. In a distributed computing environment, program modules may be located in local and/or remote memory storage devices.

As used in this application, the term “component” can be a computer-related entity, either hardware, a combination of hardware and software, software, or software in execution. For example, a component may be, but is not limited to, a process running on a processor, a processor, an object, an executable, a thread of execution, a program, and a computer. By way of illustration, an application running on a server and/or the server can be a component. In addition, a component may include one or more subcomponents and other non-computing hardware/software components.

With reference to FIG. 7, an exemplary system environment 700 for implementing the various aspects of the embodiments include a conventional computer 702, including a processing unit 704, a system memory 706, and a system bus 708 that couples various system components, including the system memory, to the processing unit 704. The processing unit 704 may be any commercially available or proprietary processor. In addition, the processing unit may be implemented as multi-processor formed of more than one processor, such as may be connected in parallel.

The system bus 708 may be any of several types of bus structure including a memory bus or memory controller, a peripheral bus, and a local bus using any of a variety of conventional bus architectures such as PCI, VESA, Microchannel, ISA, and EISA, to name a few. The system memory 706 includes read only memory (ROM) 710 and random access memory (RAM) 712. A basic input/output system (BIOS) 714, containing the basic routines that help to transfer information between elements within the computer 702, such as during start-up, is stored in ROM 710.

The computer 702 also may include, for example, a hard disk drive 716, a magnetic disk drive 718, e.g., to read from or write to a removable disk 720, and an optical disk drive 722, e.g., for reading from or writing to a CD-ROM disk 724 or other optical media. The hard disk drive 716, magnetic disk drive 718, and optical disk drive 722 are connected to the system bus 708 by a hard disk drive interface 726, a magnetic disk drive interface 728, and an optical drive interface 730, respectively. The drives 716-722 and their associated computer-readable media provide nonvolatile storage of data, data structures, computer-executable instructions, etc. for the computer 702. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment 700, and further that any such media may contain computer-executable instructions for performing the methods of the embodiments.

A number of program modules may be stored in the drives 716-722 and RAM 712, including an operating system 732, one or more application programs 734, other program modules 736, and program data 738. The operating system 732 may be any suitable operating system or combination of operating systems. By way of example, the application programs 734 and program modules 736 can include a communication facilitating scheme in accordance with an aspect of an embodiment.

A user can enter commands and information into the computer 702 through one or more user input devices, such as a keyboard 740 and a pointing device (e.g., a mouse 742). Other input devices (not shown) may include a microphone, a joystick, a game pad, a satellite dish, a wireless remote, a scanner, or the like. These and other input devices are often connected to the processing unit 704 through a serial port interface 744 that is coupled to the system bus 708, but may be connected by other interfaces, such as a parallel port, a game port or a universal serial bus (USB). A monitor 746 or other type of display device is also connected to the system bus 708 via an interface, such as a video adapter 748. In addition to the monitor 746, the computer 702 may include other peripheral output devices (not shown), such as speakers, printers, etc.

It is to be appreciated that the computer 702 can operate in a networked environment using logical connections to one or more remote computers 760. The remote computer 760 may be a workstation, a server computer, a router, a peer device or other common network node, and typically includes many or all of the elements described relative to the computer 702, although for purposes of brevity, only a memory storage device 762 is illustrated in FIG. 7. The logical connections depicted in FIG. 7 can include a local area network (LAN) 764 and a wide area network (WAN) 766. Such networking environments are commonplace in offices, enterprise-wide computer networks, intranets and the Internet.

When used in a LAN networking environment, for example, the computer 702 is connected to the local network 764 through a network interface or adapter 768. When used in a WAN networking environment, the computer 702 typically includes a modem (e.g., telephone, DSL, cable, etc.) 770, or is connected to a communications server on the LAN, or has other means for establishing communications over the WAN 766, such as the Internet. The modem 770, which can be internal or external relative to the computer 702, is connected to the system bus 708 via the serial port interface 744. In a networked environment, program modules (including application programs 734) and/or program data 738 can be stored in the remote memory storage device 762. It will be appreciated that the network connections shown are exemplary and other means (e.g., wired or wireless) of establishing a communications link between the computers 702 and 760 can be used when carrying out an aspect of an embodiment.

In accordance with the practices of persons skilled in the art of computer programming, the embodiments have been described with reference to acts and symbolic representations of operations that are performed by a computer, such as the computer 702 or remote computer 760, unless otherwise indicated. Such acts and operations are sometimes referred to as being computer-executed. It will be appreciated that the acts and symbolically represented operations include the manipulation by the processing unit 704 of electrical signals representing data bits which causes a resulting transformation or reduction of the electrical signal representation, and the maintenance of data bits at memory locations in the memory system (including the system memory 706, hard drive 716, floppy disks 720, CD-ROM 724, and remote memory 762) to thereby reconfigure or otherwise alter the computer system's operation, as well as other processing of signals. The memory locations where such data bits are maintained are physical locations that have particular electrical, magnetic, or optical properties corresponding to the data bits.

It is to be appreciated that the systems and/or methods of the embodiments can be utilized in communication facilitating computer components and non-computer related components alike. Further, those skilled in the art will recognize that the systems and/or methods of the embodiments are employable in a vast array of electronic related technologies, including, but not limited to, computers and/or handheld electronic devices, and the like.

What has been described above includes examples of the embodiments. It is, of course, not possible to describe every conceivable combination of components or methodologies for purposes of describing the embodiments, but one of ordinary skill in the art may recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates communication, comprising:
an interface component that interfaces with a plurality of communication mechanisms to obtain and/or relay communication data; and
an edge-based gateway component that receives the communication data from the interface component, determines at least one appropriate communication mechanism to facilitate routing of the communication data, and relays the communication data to an end-user via the interface component and the appropriate communication mechanism(s).

2. The system of claim 1, the communication mechanism comprising a cellular network, a public switched telephone network (PSTN), a global communication network, and/or a satellite-based network.

3. A personal computer utilizing the system of claim 1 to perform local integrated communication routing.

4. The system of claim 1 further comprising:
a gatekeeper component that facilitates in filtering communication data from being routed to an end-user by the edge-based gateway component.

5. The system of claim 1, the edge-based gateway component determines the appropriate communication mechanism based on location of an end-user, availability of an end-user, communication data routing cost-effectiveness, and/or predetermined communication data routing.

6. The system of claim 1, the interface component further comprising at least one hardware component that facilitates in interfacing with a communication mechanism.

7. The system of claim 1, the edge-based gateway component determines the appropriate communication mechanism based, at least in part, on at least one universal resource locator (URL).

8. The system of claim 1, the edge-based gateway component provides interchangeability of at least one universal resource locator and at least one telephone number to facilitate routing of the communication data.

9. The system of claim 1, the edge-based gateway component resides on a personal digital assistant (PDA), a wireless communication device, a personal computer, and/or a telephone answering device.

10. A method for facilitating communication, comprising:
obtaining, at the edge of a network, communication data from at least one of a plurality of communication mechanisms;
determining, at the edge of the network, at least one appropriate communication mechanism to facilitate routing of obtained communication data; and
relaying the obtained communication data to an end-user utilizing the appropriate communication mechanism(s).

11. The method of claim 10 further comprising:
filtering communication data at the edge of the network that is deemed undesirable by an end-user and/or an intervening entity.

12. The method of claim 11, the intervening entity comprising a computer programmed to screen communication data.

13. The method of claim 10, the communication mechanism comprising a cellular network, a public switched telephone network (PSTN), a global communication network, and/or a satellite-based network.

14. The method of claim 10, the communication data comprising voice communication data, text messaging data, and/or email data.

15. The method of claim 10 further comprising:
determining the appropriate communication mechanism based on location of an end-user, availability of an end-user, communication data routing cost-effectiveness, and/or predetermined communication data routing.

16. The method of claim 10 further comprising:
determining a plurality of appropriate communication mechanisms when an end-user's availability is ambiguous; and
relaying the obtained communication data to the end-user utilizing the plurality of appropriate communication mechanisms.

17. A system that facilitates communication, comprising:
means for obtaining, at the edge of a network, communication data from at least one of a plurality of communication mechanisms;
means for determining, at the edge of the network, at least one appropriate communication mechanism to facilitate routing of obtained communication data; and
means for relaying the obtained communication data to an end-user utilizing the appropriate communication mechanism(s).

18. The system of claim 17 further comprising:
means for filtering communication data deemed undesirable by an end-user and/or an intervening entity.

19. A device employing the method of claim 10 comprising a computer and/or a handheld electronic device.

20. A device employing the system of claim 1 comprising a computer and/or a handheld electronic device.
